(19) United States
(12) Patent Application Publication
(10) Pub. No.: US 2003/0187677 A1
(43) Pub. Date: Oct. 2, 2003

(54) Processing user interaction data in a collaborative commerce environment

(75) Inventors: Prabhakara Malireddy, Austin, TX (US); Naveen Valluri, Austin, TX (US); Sherif Issa, Austin, TX (US); Behzad Kekobad, Austin, TX (US); Amol Kher, Austin, TX (US)

Correspondence Address: T. Lester Wallace, Suite 280, 7041 Koll Center Parkway, Pleasanton, CA, 94566, US

(73) Assignee: Commerce One Operations, Inc.

(21) Appl. No.: 10/236,343

(22) Filed: Sep. 5, 2002

Related U.S. Application Data
(60) Provisional application No. 60/368,414, filed on Mar. 28, 2002.

(51) Int. Cl. G06F 17/60

(52) U.S. Cl. 705/1

(57) ABSTRACT

A user interaction analysis system receives real-time clickstream information units from a plurality of web servers and web sessions. Each information unit is associated with a single session. The analysis system uses session identifying information that is stored in a database to process the information units, to determine context values pertaining to one particular web session, and to determine that the particular web session has terminated. Upon determining that the particular web session has terminated, the analysis system generates a per-session data unit (PSDU) for that session. Each PSDU comprises click-stream information for a plurality of clicks, as well as context values, that pertain to the particular web session. The analysis system categorizes the PSDUs into a plurality of theme buckets and performs rule-based searches on the PSDUs in the buckets to identify PSDUs that meet certain search criteria. A report containing information about the identified PSDUs is generated.

### CROSS REFERENCE TO RELATED APPLICATION

This application claims the benefit under 35 U.S.C. §119(e) to the provisional application serial No. 60/368,414, entitled “Method and Apparatus for Collecting and Processing User Interaction Data to Generate Business Intelligence in Collaborative Commerce Environment,” filed on Mar. 28, 2002. The disclosure of the provisional application is incorporated herein by reference.

### TECHNICAL FIELD

The present invention relates to systems and methods for collecting and analyzing e-commerce user interaction data.

### BACKGROUND INFORMATION

FIG. 1 (Prior Art) is a diagram illustrating a prior art system 1 for collecting and analyzing e-commerce user-interaction information. In the example of FIG. 1, the web site of a seller 2 advertises and offers for sale products and/or services available from seller 2. Visitors using web browsers access the web site via the internet, clicking from web page to web page. Visitor 3 is one such visitor. Visitor 3 can order an advertised product and/or service from seller 2 by selecting (i.e., clicking on) a particular advertised product and/or service from seller 2 by selecting (i.e., clicking on) a particular link (for example, an order button) on one of the web pages. To handle the volume of traffic from many web site visitors, the web site is maintained on multiple web servers 4 and 5.

In the example of FIG. 1, a link to a web page of seller 2 is rendered by the visitor's browser 6. Visitor 3 selects the link using browser 6. This causes an associated HTTP request to be sent via a load balancing server 7 to web server 4. Web server 4 retrieves the seller's web page and returns the web page in the form of an HTTP response. In the present example, the seller's web page contains a link to a product that is offered for sale. Visitor 3 is interested in the product and therefore clicks on the link to the product. This causes a second HTTP request to be sent. This second HTTP request is sent from browser 6, via load balancing server 7 to web server 5. Web server 5 retrieves the requested web page information and returns it in the form of a second HTTP response. The second HTTP response is sent via load balancing server 7 back to browser 6, and browser 6 renders the web page. The web page illustrates the product, its price, and an order button. Although visitor 3 could order the product by clicking on the order button, the visitor 3 in this example determines that the price is too high. The visitor clicks on a back button, and eventually leaves the seller's web site without purchasing the product.

Seller 2 may wish to study the activities of visitors such as visitor 3 on the seller's web pages. Sellers may, for example, use information gleaned from web site activity to better market to potential customers. Web traffic analysis and reporting tools exist that enable sellers to analyze web site activity. Such a web traffic analysis tool is, for example, available from NetIQ Corporation, San Jose, Calif. Tools such as the WebTrends product from NetIQ generally receive user-interaction information from web servers via “web log” output files. A typical web server can be configured via a configuration file to output a “web log” containing information on web site activity. This information can include, for example, the first line of the request, the number of bytes sent, the name of a web page, the filename of an image file, the time of a request, an indication of the remote host, the type of browser a user was using, and so forth.

In the example of FIG. 1, web server 4 is configured by configuration file 8 to generate web log file 10. Web server 5 is configured by configuration file 9 to generate web log file 11. Web log files 10 and 11 contain information on many different sessions over a significant period of time, for example one day. Web logs 10 and 11 are merged into a single text file 12 and the combined user activity information from the text file is stored in a relational database 13. Once the user activity information is in database 13, a web traffic analysis tool 14 analyses it and generates reports. In the illustrated example, seller 2 can, for example, instruct the analysis tool 14 to generate a report 15 of all visitors to the seller's web site.

The system of FIG. 1 has operational shortcomings. For example, the system has difficulty collecting and reporting on session-based information. Consider a situation in which seller 2 wishes to have a report generated shortly after a visitor (such as visitor 3) concludes a session in which the visitor checked a product price but then concluded the session without purchasing the product. To generate such a report, the system 1 merges large web logs 10 and 11 because some of the needed information is in web log 10, whereas the rest is in web log 11. The derivation of session-based information by the merging of large web logs may involve significant computational complexity that delays the arrival of information into the database. Not only may the derivation of session-based information be computationally intensive, but it may also be undesirably slow. Web servers are typically configured to collect information in log files over significant periods of time, for example days or weeks. In the example of FIG. 1, log information on the pertinent session in which visitor 3 left the web site would usually not reach database 13 until a significant period of time has passed. The generation of reports therefore involves undesirable computational complexity and latency. An improved analysis tool is sought.

### SUMMARY

A user interaction analysis system receives real-time clickstream information units from a plurality of web servers and from a plurality of web sessions. Each real-time click-stream information unit is associated with a single session. The analysis system uses session identifying information that is stored in a database to process the real-time clickstream information units, to determine a context value pertaining to one particular web session, and to determine that the particular web session has terminated. Upon determining that the particular web session has terminated, the analysis system generates a per-session data unit (PSDU) for the particular web session. Each PSDU comprises click-stream information for a plurality of mouse clicks pertaining to the particular web session, as well as context values pertaining to the particular web session. The analysis system generates a new PSDU for each different web session and categorizes the PSDUs into a plurality of theme buckets, which are stored in a database. A rule-based search is performed on the PSDUs in the various theme buckets to identify one or more PSDUs that meet a plurality of search criteria. The analysis system generates a report containing information about the identified PSDU or PSDUs and outputs the report. The report may, for example, be displayed using a graphical user-interface.

This summary does not purport to define the invention. The invention is defined by the claims.

### BRIEF DESCRIPTION OF THE DRAWINGS

The present invention is illustrated by way of example and not limitation in the figures of the accompanying drawings, in which:

FIG. 1 (Prior Art) is a diagram of an analysis system that relies on web logs;

FIG. 2 is a simplified diagram of one embodiment in accordance with the present invention;

FIG. 3 is a flowchart of a method carried out by the user interaction analysis system shown in FIG. 2; and

FIG. 4 is a diagram illustrating the contents of a per-session data unit (PSDU).

### DETAILED DESCRIPTION

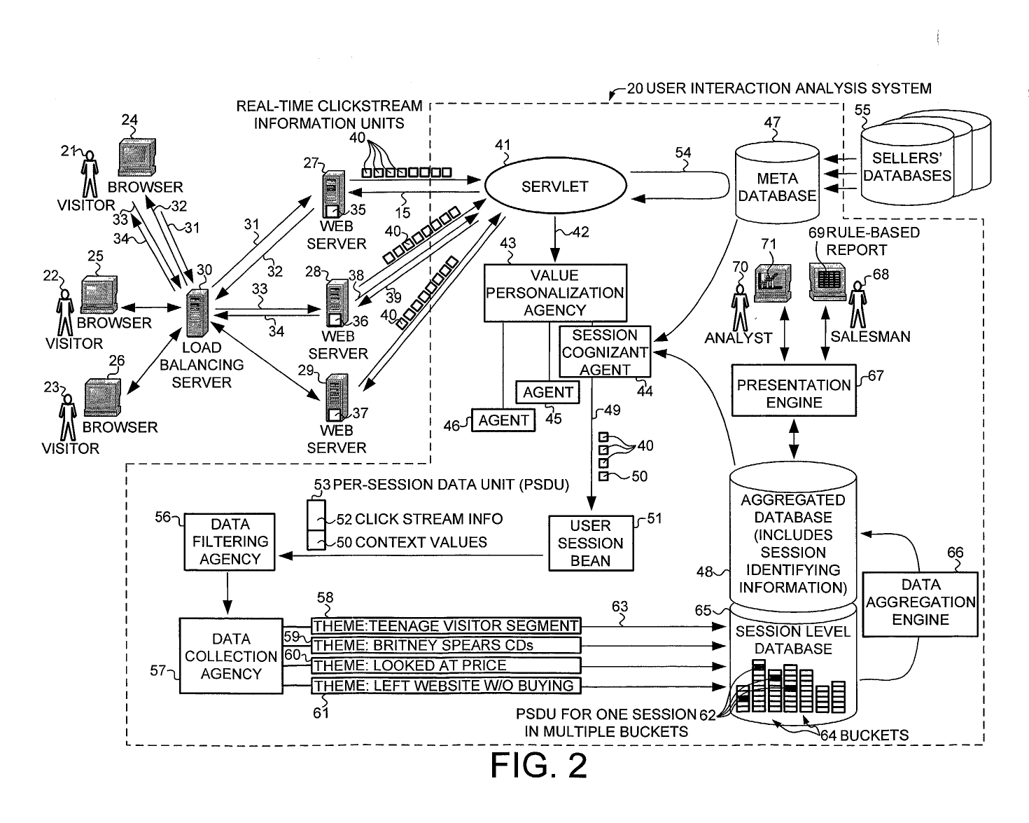

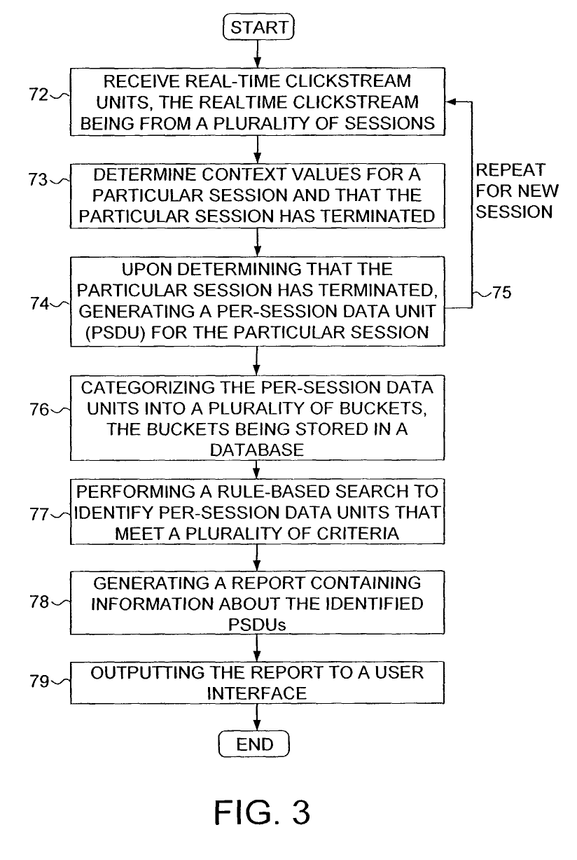

FIG. 2 is a diagram illustrating a user interaction analysis system 20 for collecting and analyzing e-commerce user-interaction information. Operation of system 20 is described in connection with the method set forth in FIG. 3. In the embodiment depicted in FIG. 2, three visitors 21-23 are using web browsers 24-26 to access a web site of a particular seller via the internet. The visitors have the ability to click from web page to web page and thereby to view a plurality of web pages from a plurality of web sites. The seller advertises and offers for sale products and/or services to visitors 21-23. Visitor 21 can order an advertised product and/or service from the seller by selecting (i.e., clicking on) a particular link (for example, an order button) on one of the web pages. In this example, visitor 21 selects a particular link to a new web page of the seller containing information on a new product, and browser 24 of visitor 21 sends an HTTP request 31 to a web server 27 on which the web pages of seller's web site have been loaded.

To handle the volume of traffic from many web site visitors, the web site is maintained on multiple web servers 27-29. In this way, the web pages can be served up to a plurality of visitors simultaneously. Each HTTP request is forwarded via a load balancing server 30 to a non-overloaded web server. In the present example, the HTTP request 31 for the new product web page is directed by load balancing server 30 to web server 27. Web server 27 retrieves the new product web page and returns the web page in the form of an HTTP response 32 to visitor 21.

Visitor 21 is interested in the product and therefore clicks on the link to order the product. This causes a second HTTP request 33 to be sent. This second HTTP request 33 is sent from browser 24, via load balancing server 30 to web server 28. Web server 28 retrieves the requested order web page and returns it in the form of a second HTTP response 34 via load balancing server 30 back to browser 24. The order web page illustrates the product, its price, and an order button. Although visitor 21 could order the product by clicking on the order button, the visitor 21 in this example determines that the price is too high. The visitor clicks on a back button and eventually leaves the seller's web site without purchasing the product.

In this example, the seller's order web page contains both static and dynamic information. The static information is stored on web server 27 and includes, for example, a graphics file illustrating the product. The seller changes the graphics file infrequently and does so by updating (reloading) the web pages of seller's web site onto web servers 27-29. The seller's order web page also includes dynamic information, such as the price of the product, which might change frequently. This dynamic information is not stored on web servers 27-29. Instead, web servers are commonly programmed to ask applications servers for dynamic information, which the web servers then plug into the appropriate fields on the web pages they serve to visitors. In this example, the web server 28 makes a request 38 to the user interaction analysis system 20 for the dynamic information (including product price) on the order web page. The user interaction analysis system 20 responds 39 to the web server 28 with the price of the product, and the HTTP response 34 includes this dynamic information.

The seller desires to know, on a real-time basis, how visitor 21 acted during the web session during which visitor 21 looked at the seller's web site. The seller in this example does not use existing web traffic analysis tools because these tools rely on analyzing “web logs” produced by web servers 27-29. Relying on web logs creates several problems.

The usefulness of information contained in conventional web logs is relatively low because it is difficult to separate and correlate the individual pieces of that information. For example, the name of a web page or the filename of an image file are of little use if they are not correlated in meaningful ways to characteristics of things that are of interest to the seller, such as visitor 21 or the seller's product.

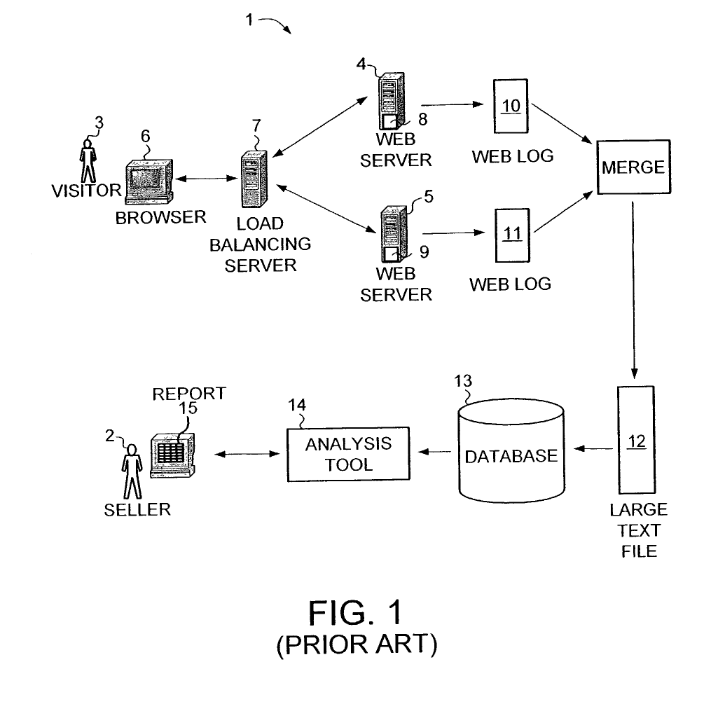

It is difficult to separate and correlate relevant information in web logs because they are typically voluminous. Web logs are voluminous because they are not produced by web servers after each web session. Instead, they are produced only infrequently, such as once per day or per week. In addition, if visitor 21 clicks back and forth between the illustration page and the order page, the same information obtained from these pages is included multiple times in the web logs. Not only do web logs contain information relating to multiple clicks, but web log files produced in the example of FIG. 1 also contain information on many different sessions, not just the session of visitor 21. It is helpful to separate information relating to the session of visitor 21 from information relating to a multitude, potentially millions, of other sessions. The typical overall size of web logs, e.g., up to even gigabytes, complicates this separation and correlation process.

The separation and correlation process is further complicated because all of the information from one web session is not included in one web log where load balancing is used. In order to gather all of the information concerning the entire web session during which visitor 21 looked at the product, information needs to be gleaned from the web logs of multiple web servers, here at least web servers 27 and 28. Correlating the information from a plurality of voluminous web logs in order to put together the information that relates to one web session requires complex and time-consuming computation and may not be entirely successful. Even if web logs were produced more frequently than once per day, the complex computations required to glean and collate data relating to individual web sessions from among multiple web logs would render the results non-real-time. The separation and correlation process becomes even more complex in the context of dynamic web pages, which are becoming more commonplace. Even more complex computations are required to correlate dynamic information because that information is relevant only with respect to a specific period in time.

Instead of relying on web logs, the seller in the example of FIG. 1 relies on an aspect of the user interaction analysis system 20 to determine how visitor 21 acted during his web session. The web servers 27-29 are configured via configuration files 35-37 to output real-time clickstream information units 40. A non-exhaustive list of the types of information that can be included in the real-time clickstream information units 40 is:

the visitor's IP address;

the remote username of the visitor;

the HTTP filename;

number of bytes sent by the web server, excluding HTTP headers;

the uniform resource locator (URL) path requested by the visitor;

the time taken to serve the visitor's request;

the browser used by the visitor; and

the contents of headers and notes (both static and dynamic contents).

Upon each HTTP request (from a click) of the visitor 21, web servers 27-29 send a real-time clickstream information unit 40 to servlet 41. Servlet 41 receives the real-time clicksteam information units (FIG. 3, step 72) for each click. Because each real-time clicksteam information unit 40 relates to a single click, each information unit 40 also relates to a single session. Servlet 41 receives information units 40 from a plurality of web servers and from a plurality of web sessions (e.g., also from web sessions of visitors 22 and 23) and forwards 42 the information units 40 to the value personalization agency 43. If the configuration files 35-37 cannot be programmed to delete the contents of headers and notes (e.g., graphics files) from the real-time clickstream information units 40, then the servlet 41 can filter out the content files from the information units 40 that it forwards to the value personalization agency 43. Note, however, that the servlet 41 can delete the contents of a file without deleting the name of the file, which imparts the fact that the particular file was requested.

The value personalization agency 43 comprises session cognizant agents (3 of which are shown as 44-46), which use information stored in databases 47-48 to identify those information units 40 that belong to a particular session. The information in databases 47-48 used by the session cognizant agents 44-46 can include information related to past sessions of visitor 21. Each session cognizant agent determines when a particular session has begun and terminated (step 73) and gathers the information units 40 that belong to that one session. The session cognizant agent 44 combines all of the information units 40 related to the session (here called click stream information 52) with context values 50 that relate to the particular session. The session cognizant agent 44 can itself assign certain context values, such as a unique session number and an indication of the length of the session.

For each subsequent web session that the value personalization agency 43 identifies, a new session cognizant agent gathers the information units 40 and the context values 50 related to that session and forwards 49 them to a user session bean 51. From this correlated and gathered combination of clickstream information 52 and context values 50, the user session bean 51 generates per-session data units (PSDUs) 53 (step 74), which the user session bean 51 forwards to a data filtering agency 56. The user session bean 51 generates a new PSDU (step 75) for each new session.

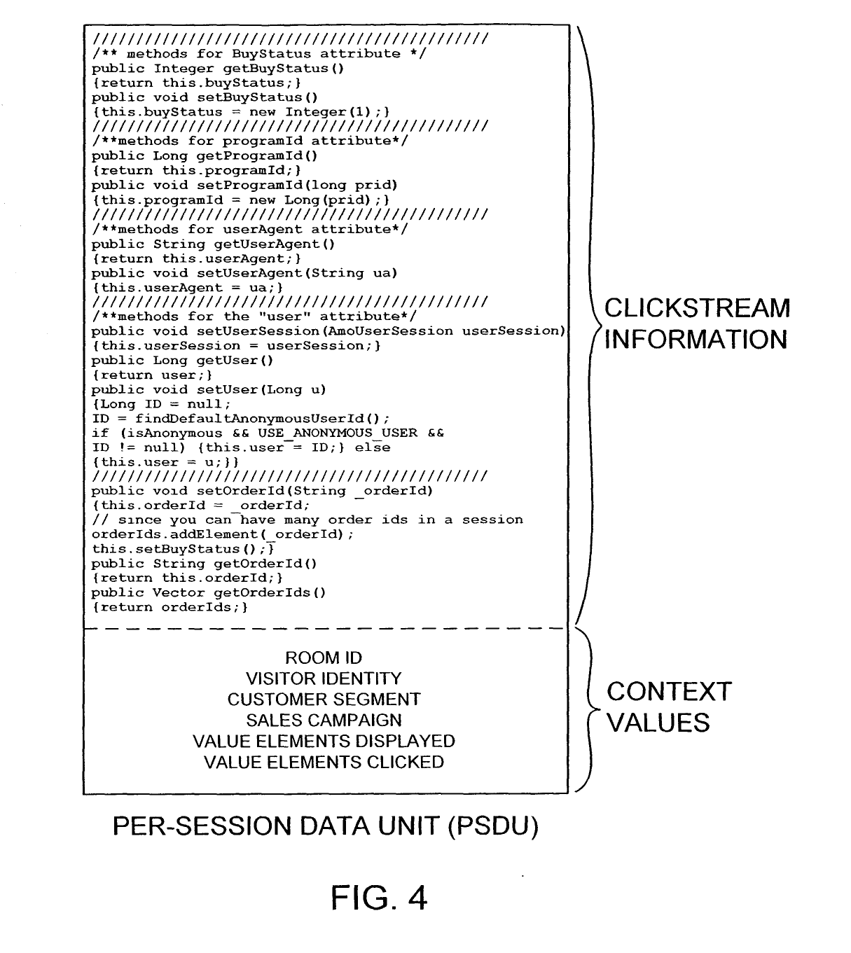

FIG. 4 illustrates an example of how clickstream information 52 and context values 50 are conveyed in the per-session data units. Sample context values and sample java code for clickstream information is contained within the relevant box in the figure. Examples of context values include: (i) room ID of one of the internet room into which seller's website is divided, (ii) visitor identity obtained by mapping login information of visitor to her profile, (iii) customer segment to which visitor belongs, (iv) sales campaign or banner advertisement through which visitor entered website of seller, (v) value elements displayed to visitor, and (vi) value elements clicked by visitor.

In the example of the web session of visitor 21, the product is a music CD from Britney Spears. The web server 28 made the request 38 to servlet 41 for the dynamic information (including the offered price for the CD) on the order web page. The servlet 41 requested 54 this dynamic information from the meta database 47, which is regularly updated to include the dynamic information from the individual databases 55 of a plurality of sellers. The session cognizant agent 44 gathers context values from the web session of visitor 21, which can include dynamic information located in database 47, such as the offered price of the CD. The agent 44 also gathers other context values that are found in the aggregated database 48 and that also relate to the web session of visitor 21. Context values for the particular web session of visitor 21 that can be determined from the aggregated database 48 include: the area (“room”) of the seller's web site in which the CD was displayed, the type of visitor (“customer segment”) that would likely be interested in a CD from Britney Spears, the relevant overall sales campaign of the seller to sell products related to Britney Spears, the likely true identity of visitor 21 (obtained from userame, IP address and past signup information from visitor 21) and any “value elements” that are not readily apparent and that seller believes could induce visitor 21 to buy the CD, for example a cash rebate or free concert tickets.

The user session bean 51 receives the clickstream information 52, including dynamic information, and the context values 50 related to the web session of visitor 21 and creates a single PSDU 53 from that information. The user session bean 51 then sends the PSDU 53 to the data filtering agency 56. The data filtering agency 56 filters out specific data from PSDUs 53 that violates rules defined to protect visitors' privacy. After passing the data filtering agency 56, PSDUs 53 enter the data collection agency 57. The data collection agency 57 categorizes the PSDUs 53 into a plurality of themes defined by the seller (step 76). In FIG. 2, four themes 58-61 are shown. The data collection agency 57 may sort a particular PSDU into several applicable themes 62, or into no theme if the contents of a PSDU does not fulfill the defined criteria for any specific theme. After the data collection agency 57 sorts a PSDU into a pre-defined theme, the PSDU is sent 63 to be stored in a bucket 64 for that theme in a session level database 65 (step 76).

Over a period of time, the PSDUs in the theme buckets 64 in the session level database 65 are aggregated by a data aggregation engine 66 and placed in the aggregated database 48. The data aggregation engine 66 aggregates the PSDUs in dimensions other than the categories of the themes, for example aggregating PSDUs within a specific theme that were generated during a specific time frame or from IP addresses thought to be in a specific geographic location.

The seller can instruct a presentation engine 67 to generate a rule-based report that relies on the information in the aggregated database 48 and that presents the information that fulfills the search criteria (step 77). In the illustrated example, the seller desires to know how visitor 21 acted during the web session during which visitor 21 looked at the seller's web site. More specifically, a salesman 68 for the seller might want to be alerted, on a real-time basis, of the last web session in which a visitor looked at a product, then looked at the product's price and then left the seller's web site. Through email, telephone or on the web site itself, the salesman could then offer a lower price or present a value element to induce visitor 21 to purchase the CD. The lower price or the value element would not need to be offered to those visitors who purchase during the web session.

Alternatively, the salesman 68 can generate a rule-based report 69 (step 78) that shows, in tabular form according to sales region and time since the web session, all PSDUs that were sorted into all four themes: (i) teenage visitor segment 58, (ii) Britney Spears CDs 59, (iii) looked at price 60, and (iv) left website without buying 61. The report is displayed using a graphical user interface (step 79). The salesman then uses this information to determine how the price point for the Britney Spears CD should decrease as the CD ages.

In addition, in the present example, a financial analyst 70 for the seller generates a rule-based report 71 that shows trends over time in how visitors have acted on the seller's web site, such as how much revenue was obtained from visitors related to each room, product, customer segment or sales campaign.

Although certain specific exemplary embodiments are described above in order to illustrate the invention, the invention is not limited to the specific embodiments. Accordingly, various modifications, adaptations, and combinations of various features of the described embodiments can be practiced without departing from the scope of the invention as set forth in the following claims.

What is claimed is:

1. A method, comprising:
(a) receiving real-time clickstream information units from a plurality of web servers, the real-time clickstream information units being from a plurality of sessions, each real-time click-stream information unit being associated with a single session;
(b) using session identifying information stored in a database to: 1) process the real-time clickstream information units, 2) determine a context value pertaining to one particular session, and 3) determine that the particular session has terminated;
(c) upon determining that the particular session has terminated, generating a per-session data unit (PSDU) for the particular session, the per-session data unit comprising:
1) click-stream information for a plurality of clicks pertaining to the particular session, and 2) the context value pertaining to the particular session;
(d) generating many per-session data units using steps (b) and (c), each per-session data unit pertaining to a different session;
(e) categorizing the per-session data units into a plurality of buckets, the buckets being stored in a data base;
(f) performing a rule-based search to identify one or more per-session data units in the buckets that meet a plurality of criteria; and
(g) generating a report containing information about the identified one or more per-session data units, and outputting the report to a user-interface (Ul).

2. The method of claim 1, wherein the session identifying information in (b) comprises information identifying a plurality of web pages that together comprise a web site.

3. The method of claim 1, wherein the context value in (b) is taken from the group consisting of: a customer segment value, a room-visited value, a product-visited value, a sales campaign value, a visitor identity value, and a value for a value element.

4. The method of claim 1, wherein multiple click-stream information units are received in (a) that pertain to the same single session.

5. The method of claim 1, wherein each click-stream information unit in (a) relates to one and only one key click.

6. The method of claim 1, wherein the per-session data unit of (c) contains first clickstream information received from a first one of the plurality of web servers as well as second click-stream information received from a second one of the plurality of web servers.

7. The method of claim 1, wherein multiple click-stream information units are received in (a) that pertain to the same single session.

8. The method of claim 1, wherein one of the click-stream information units in (a) is output from one of the web servers in response to a web site visitor using a browser to select a link on a web page, the click-stream information being output from the web server within one minute of the visitor selecting the link.

9. The method of claim 1, wherein a first one of the buckets in (e) contains only per-session data units containing a first customer segment value, and wherein a second one of the buckets in (e) contains only per-session data units containing a second customer segment value.

10. The method of claim 1, wherein one of the buckets in (e) contains only per-session data units for sessions wherein during a session a web site visitor accessed price information pertaining to a product offered for sale on a web site but then terminated the session without purchasing the product.

11. The method of claim 1, wherein the report in (g) is an alert that is displayed by the UI, the alert identifying a web site visitor who terminated a session without purchasing a product offered for sale on the web site, the report being displayed within ten minutes of the session being terminated.

12. A computer-readable medium having computer-executable instructions for performing the steps of:
(a) receiving real-time clickstream information units from a plurality of web servers, the real-time clickstream information units being from a plurality of sessions, each real-time click-stream information unit being associated with a single session;
(b) using session identifying information to: 1) process the real-time clickstream information units, 2) determine a context value pertaining to one particular session, and 3) determine that the particular session has terminated;
(c) generating a per-session data unit (PSDU) for the particular session, the per-session data unit comprising: 1) click-stream information for a plurality of clicks pertaining to the particular session, and 2) the context value pertaining to the particular session;
(d) generating many per-session data units using steps (b) and (c), each per-session data unit pertaining to a different session;
(e) categorizing the per-session data units into a plurality of buckets, the buckets being stored in a data base;
(f) performing a rule-based search to identify per-session data units in the buckets that meet a plurality of criteria; and
(g) generating a report containing information about the identified per-session data units.
